(19) United States
(12) Patent Application Publication
(10) Pub. No.: US 2021/0174309 A1
(43) Pub. Date: Jun. 10, 2021

(54) UPDATING ALARM SETTINGS BASED ON A MEETING INVITATION THAT IS RECEIVED OUTSIDE OF PREDEFINED BUSINESS HOURS

(71) Applicant: MICROSOFT TECHNOLOGY LICENSING, LLC, Redmond, WA (US)

(72) Inventors: Shalendra CHHABRA, Seattle, WA (US); Eric Randall SEXAUER, Woodinville, WA (US); Tiphanie LAU, Seattle, WA (US)

(21) Appl. No.: 16/708,363

(22) Filed: Dec. 9, 2019

(51) Int. Cl. G06Q 10/10

(52) U.S. Cl. CPC G06Q 10/1095

(57) ABSTRACT

A system for updating alarm settings based on a meeting invitation that is received outside of predefined business hours. The system monitors incoming communications on behalf of a user to determine when a meeting invitation that is received outside of the predetermined business hours satisfies one or more criteria that have been previously defined by the user. Then, the system updates alarm settings on behalf of the user. In this way, the system can update an alarm time when a meeting request is received during nighttime hours without the user being disturbed. The updated alarm settings cause a client device to sound an alarm signal at an updated time that is earlier than a user-defined time—thereby alerting (e.g., waking) the user with enough time to participate in the requested meeting at the requested time and without disturbing the user in the middle of the night.

### BACKGROUND

Modern businesses are becoming increasingly globalized and as a result many business units include team members from around the world. For this reason, work activities for any particular business unit often occur around the clock since regular business hours for team members that reside in one part of the world may occur during the middle of the night for other team members that reside in some other part of the world. Furthermore, the globalized nature of modern businesses means that meetings between distant colleagues are often scheduled at times when for some participants it is very early in the morning whereas for other participants it is very late in the day. For example, a meeting scheduled for 6:30 PM India Standard Time (IST) will correspond to 6:00 AM Pacific Daylight Time (PDT). The globalized nature of modern businesses also means that meeting invitations may be sent during normal business hours for the sender but may be received in the middle of the night by recipients. For example, if a team member from India sends a meeting invitation to a colleague in Seattle, Wash. at 4:00 PM IST to request participation in a meeting at 6:30 PM IST, the colleague in Seattle, Wash. will receive the invitation around 3:30 AM PDT—a mere two and one-half hours before the requested meeting time.

Unfortunately, receiving a meeting invitation on such short notice and in the middle of the night will likely result in one of two undesirable outcomes. The first undesirable outcome is that the colleague in Seattle, Wash. misses the meeting altogether because his or her alarm is scheduled to go off sometime after the meeting would have already taken place. The second undesirable outcome is that the colleague in Seattle, Wash. is woken up in the middle of the night by, for example, the meeting invitation causing a notification to sound on a client device.

It is with respect to these and other considerations that the following disclosure is made.

### SUMMARY

The techniques disclosed herein enable a system to update alarm settings based on a meeting invitation that is received outside of predefined business hours. Generally described, a system can monitor incoming communications on behalf of a user to determine when a meeting invitation is received outside of predetermined business hours and, ultimately, to then update alarm settings when the meeting invitation meets one or more alarm update criteria. For example, suppose that prior to going to sleep one evening, a user defines alarm settings to cause a client device to sound an alarm signal the next morning at a user-defined time. Further suppose that at some later time outside of scheduled business hours while the user is asleep prior to the user-defined time (e.g., before the alarm goes off), a meeting invitation is received which requests that the user participate in a meeting that will occur before the user-defined time. Thus, unless the user is woken during the night or the alarm time changed appropriately, the user will likely sleep past the requested meeting time. In such an example, the system can determine whether the meeting invitation meets alarm update criteria which may have been previously defined by the user. Then, in the event that the meeting invitation does meet the alarm update criteria, the system can then update the alarm settings to cause the client device to sound the alarm signal at an updated time that is earlier than the user-defined time—thereby alerting (e.g., waking) the user with enough time to enable the user to participate in the requested meeting at the requested time.

In various implementations, the techniques disclosed herein provide the user with an ability customize at least some aspects of the alarm update criteria associated with his or her user account to cause the system to automatically (e.g., without user intervention) update alarm settings in a manner that specifically suits his or her preferences. As one example, a user may define a first time-range during which a meeting invitation must be received in order for the alarm update criteria to be satisfied. In this way, the user may prevent the system from acting on his or her behalf by automatically updating alarm settings based on meeting invitations that are received outside of this “user-defined” first time-range. An exemplary such “user-defined” first time-range may correspond to reduced notification hours during which a client device is prevented from exposing certain types of notifications. As another example, the user may define a second time-range outside of which meeting participation must be requested in the meeting invitation in order for the alarm update criteria to be satisfied. In this way, the user may prevent the system from acting on his or her behalf by automatically updating alarm settings based on meeting invitations that are requesting the user to participate in meetings which will occur during the second time-range. An exemplary such second time-range may correspond to regularly scheduled business hours. It can be appreciated that by defining the first time-range and/or second time-range within the alarm update criteria as described above, the user can cause the system to update the user-defined alarm settings if, and only if, a meeting invitation is received during the first time-range (e.g., the reduced notification hours) and/or the meeting invitation requests meeting participation outside of the second time-range (e.g., prior to the regularly scheduled business hours). A major technical benefit of such an embodiment is that the user can put a client device into a reduced notification mode to prevent unwanted disruptions during some period of time (e.g., through the night) while also deploying the system to analyze meeting invitations received during this period of time and to update alarm settings appropriately to cause the client device to sound an alarm in time for the user to attend any relevant meetings that were scheduled during this period of time.

The techniques described herein may also enable the user to define various types of alarm update permissions within the alarm update criteria that uniquely correspond to his or her user account. In some implementations, alarm update permissions may be defined by the user to cause the system to update the alarm settings in response to meeting invitations that are received from one or more predefined sending accounts. For example, the user may define a particular user account (e.g. by an “email alias” or some other suitable identifier) within the alarm update permissions as well as certain alarm update criteria indicating circumstances under which the system is to automatically update alarm settings on behalf of the user in response to a meeting invitation being received from the particular user account. In this way, the user can predefine circumstances under which meeting invitations being received from certain important individuals (e.g., the user's boss, certain team members, etc.) may warrant updating of the alarm settings. Then, if a meeting invitation is received from one of these predefined important individuals, and any other alarm update criteria are also satisfied, then the system can automatically update the alarm settings associated with the user's account to ensure that the user is alerted of meetings that are requested by these predefined important individuals prior to requested meeting times.

Additionally, or alternatively, the techniques described herein may enable the user to define alarm update permissions that permit automatically updating of the alarm settings if, and only if, a meeting invitation is received in association with a predefined time zone or a predefined geolocation. In this way, the user can limit the system to only update the alarm settings on his or her behalf when meeting invitations are received from other users that are currently working from some predefined areas of the world. It can be appreciated that such embodiments may be beneficial to users whom strive to increase their availability and flexibility for accommodating meeting times being requested from team members working within various other time zones. Additionally, or alternatively, the techniques described herein may enable the user to define alarm update permissions that permit automatically updating of the alarm settings if, and only if, a meeting invitation is received during some predefined date-range. For example, if the user would like to provide additional support for a team member that is temporarily traveling internationally to some part of the world many time zones away from the user, then the user may define the time period during which this other team member will be traveling to accommodate provisioning of this support.

In some implementations, the system can identify relevant aspects of the meeting invitation such as, for example, a meeting location or traffic conditions to determine an appropriate amount of buffer time between an updated time to sound the alarm signal and the requested meeting time. For example, the system may parse the meeting invitation to determine that the meeting is to take place on an enterprise campus at some early time that is prior to the scheduled business hours. In this example, the system may determine an amount of buffer time that will provide the user with sufficient time prior to the requested meeting time to wake up, get ready at home, and then commute to the enterprise campus in time for the requested meeting. Alternatively, parsing the meeting invitation may instead reveal that the requested meeting is an internet-based teleconference type meeting which the user can participate in from home. Under these alternate circumstances, the system may determine some lesser amount of buffer time as compared to the other scenario where the user would have to commute to the enterprise campus in time for the requested meeting.

Thus, the system described herein can identify meeting invitations that are received outside of predefined business hours to automatically (e.g., without user intervention) update user-defined alarm settings in a manner that is both timely and contextually appropriate based on relevant aspects of the meeting invitation. These novel abilities of the system described herein provides a number of technical benefits over conventional alarm systems. For example, automatically updating user-defined alarm settings on behalf of a user in response to a meeting invitation being received outside predefined business hours reduces, or even eliminates, a need for the user to interact with a client device outside of the predefined business hours to timely react to such meeting invitations. For example, the technologies described herein may eliminate the need for the user to read meeting invitations received during night hours and react by manually updating his or her alarm settings accordingly to ensure attendance to newly scheduled early morning meetings. Thus, the technologies described herein provide at least the technical benefit of improving user interaction with a computing device. Such techniques can increase the efficiency of a computing system by reducing the number of times a user needs to interact with (e.g., by “waking”) a computing device to obtain relevant information from newly received meeting invitations. Thus, the usage of various computing resources such as network resources, memory resources, and processing resources can be significantly reduced. Moreover, by automating the updating the alarm settings, user interaction with the computing device can be improved. The reduction of manual data entry and improvement of user interaction between a human and a computer can result in a number of other benefits. For instance, by reducing the need for manual entry, inadvertent inputs and human error can be reduced. This can ultimately lead to more efficient use of computing resources such as memory usage, network usage, processing resources, etc.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates an exemplary scenario for a system to update alarm settings based on a meeting invitation that is received outside of predefined business hours.

FIG. 2A illustrates a scenario in which the alarm settings are updated on behalf of a user in response to a meeting invitation being received during a first time-range and requesting meeting participation that is to begin prior to a second time-range.

FIG. 2B illustrates a scenario in which the alarm settings are updated on behalf of a user in response to a meeting invitation being received outside of a particular time-range.

FIG. 2C illustrates a scenario in which the alarm settings are updated on behalf of a user in response to a meeting invitation originating from a particular sending account.

FIG. 2D illustrates a scenario in which the alarm settings are updated on behalf of a user in response to a meeting invitation being associated with a particular location and/or time zone.

FIG. 2E illustrates a scenario in which alarm update criteria define conditions related to determining an amount of buffer time based on a requested meeting start time

FIG. 2F illustrates a scenario in which alarm update criteria may define conditions related to determining whether to update alarm settings based on an importance level indicated for a meeting invitation.

FIG. 3 illustrates an exemplary graphical user interface that may be displayed to enable a user to define alarm update criterion in association with one or more particular user accounts.

FIG. 4A illustrates an exemplary graphical user interface (GUI) that includes a notification to inform a user of alarm settings being automatically updated in response to a meeting invitation being received.

FIG. 4B illustrates an exemplary GUI that includes a notification to inform a user of alarm settings being automatically updated in response to a meeting cancellation being received.

FIG. 5 is a diagram illustrating aspects of a routine for updating alarm settings associated with a user account in response to a meeting invitation that satisfies one or more alarm update criteria being received in association with the user account.

FIG. 6 illustrates a diagram that shows various components of an example device (also referred to herein as a “computing device”) configured to implement various operations described herein.

### DETAILED DESCRIPTION

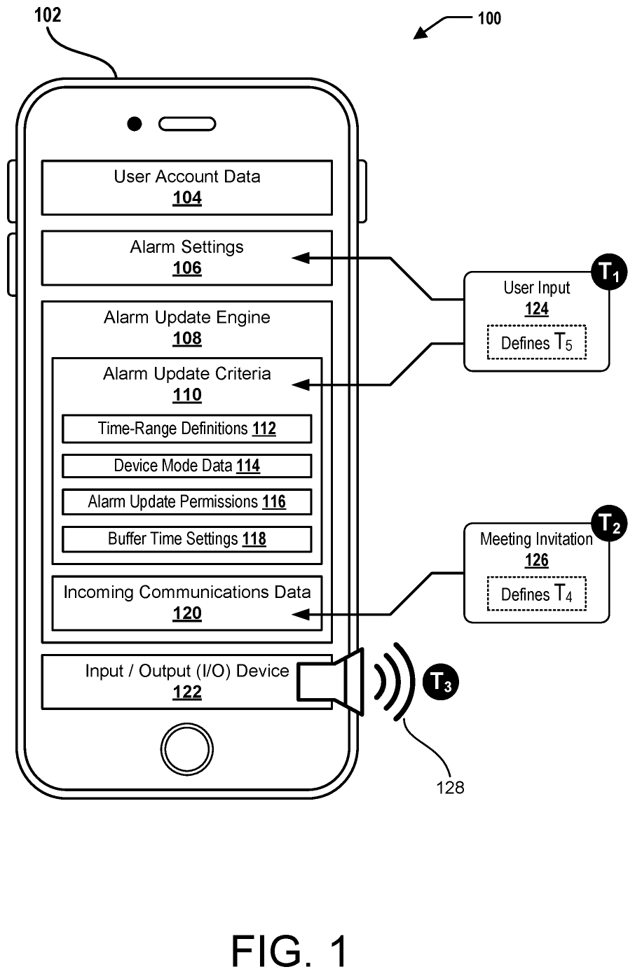

FIG. 1 illustrates an exemplary scenario for a system 100 to update alarm settings 106 based on a meeting invitation 126 that is received outside of predefined business hours. The technologies disclosed herein with respect to the system 100 provide improvements over existing alarm systems which lack functionality for monitoring incoming communications on behalf of a user and automatically (e.g., without user intervention) updating alarm settings when the monitored communications include meeting invitations that meet one or more alarm update criteria. For example, existing alarm systems are typically restricted to generating (e.g., audibly sounding) an alarm signal at some previously provided user-defined time (e.g., an alarm time that is manually set by a user prior to going to bed). Thus, under circumstances where meeting invitations 126 could potentially be received outside of predefined business hours to request participation in a meeting at some time prior to the previously provided user-defined time (which may even be prior to the predefined business hours), the aforementioned technical limitations of existing alarm systems compel many users to monitor incoming communications outside of the predefined business hours and to manually update the alarm settings 106 when certain meeting invitations are received. Unfortunately, this is an intensely cumbersome process—especially when such meeting invitations 126 could potentially be received during nighttime hours when these users are attempting to rest. In contrast, the techniques described herein enable a user to define alarm update criteria 110 in accordance with his or her preferences and then deploy the system 100 to automatically update the alarm settings 106 in response to meeting invitations 126 being received under circumstances which satisfy the user-defined alarm update criteria 110.

Thus, the techniques described herein mitigate, or even wholly eliminate, a necessity for the user to interact with a client device outside of the predefined business hours to timely react to important meeting invitations by manually updating the alarm settings 106. For example, upon a user successfully defining alarm update criteria 110 in accordance with his or her preferences, the technologies described herein may eliminate the need for this user to read meeting invitations received during nighttime hours and react by manually updating his or her alarm settings 106 accordingly to ensure attendance to early morning meetings that are scheduled on short notice. For at least the foregoing reasons, the technologies described herein provide the technical benefit of improving user interaction with a computing device. Such techniques can increase the efficiency of a computing system by reducing the number of times a user needs to interact with (e.g., by “waking”) a computing device to obtain and react to relevant information included within newly received meeting invitations 126. Thus, the usage of various computing resources such as network resources, memory resources, processing resources, and power resources (e.g., “battery”) can be significantly reduced.

As illustrated in FIG. 1, the system 100 may deploy a computing system to perform one or more of the various operations described herein and/or to store various types of data described herein. Although illustrated in the form of a client device 102 (e.g., a smart phone), the computing system may be any suitable form such as, for example, a desktop computer, a laptop computer, a smartwatch, one or more server computers, and so on. In the illustrated embodiment, the client device 102 may store (or otherwise have access to) user account data 104 that defines aspects of a user account for a user that is associated with the client device 102 and for whom the alarm settings 106 are updated on behalf of The client device 102 is shown to further store (or otherwise have access to) other types of data described herein which may include, but are not limited to, the alarm settings 106, the alarm update criteria 110, and incoming communications data 120. Additionally, or alternatively, various types of data described herein may be stored remotely on the one or more servers and may be accessed or provided to the client device 102. Also in the illustrated embodiment, the client device 102 may execute an alarm update engine 108 to determine when and how to update the alarm settings 106 on behalf of the user in response to certain meeting invitations 126 being received in association with the user account for the user (e.g., an email inbox of the user). Additionally, or alternatively, various operations described herein with relation to the alarm update engine 108 may be performed remotely on one or more servers.

Aspects of the exemplary scenario for the system 100 to update the alarm settings 106 in FIG. 1 are described with respect to a first time T₁ through a fifth time T₅. For purposes of the present discussion, these times represent a sequence of times in which: T₁<T₂<T₃<T₄<T₅ (where < means “prior to”). In the exemplary scenario, the system 100 determines alarm settings 106 that prescribe a user-defined time for generating an alarm signal 128 and also alarm update criteria 110 that prescribes when and how the alarm update engine 108 is to automatically update aspects of the alarm settings 106 on behalf of the user. Here, the alarm settings 106 and the alarm update criteria 110 are both provided to the system 100 at (or prior to) a first time T₁ via user input 124. Additionally, or alternatively, some or all of the alarm update criteria 110 may be provided to the client device 102 via one or more remote resources in the form of “default” alarm update criteria 110 (e.g., which have not been uniquely defined by a particular user). In the exemplary scenario, the user-defined time is set to the fifth time T₅ which may be shortly before scheduled work hours associated with the user account. For purposes of the present discussion of FIG. 1, presume that the user-defined time T₅ is set to 7:30 AM and that scheduled work hours begin 1 hour later at 8:30 AM. Thus, in the exemplary scenario of FIG. 1, the user has manually defined an alarm time of 7:30 AM to afford herself or himself enough time to wake up and get to work by 8:30 AM.

At a second time T₂ (which is subsequent to the first time T₁ and prior to the fifth time T₅), the system 100 monitors incoming communications data 120 on behalf of the user and identifies a meeting invitation 126 that is received in association with the user account. Exemplary forms of incoming communications data 120 may include, but are not limited to, data corresponding an email inbox, text messages, or any other form of communications data that is suitable for communicating the meeting invitation 126. In some embodiments, the meeting invitation 126 may be in the form of an electronic calendar data object such as, for example, a MICROSOFT OUTLOOK meeting request that is sent to an email address corresponding to the user account. In such embodiments, the system 100 may parse the meeting invitation 126 based on various predefined fields to extract relevant aspects of the meeting invitation 126. For example, the system 100 may extract information from a “From” field to identify the sending account from which the meeting invitation 126 originated. Additionally, or alternatively, the system 100 may extract information from a “Start Time” field to identify a meeting start time associated with the requested meeting. Additionally, or alternatively, the system 100 may extract information from a “Location” field to identify a location at which the requested meeting is to take place. The identified location may be a physical location (e.g., a conference room, a street address, etc.) or a virtual location (e.g., a hyperlink to a teleconference session, a.k.a. a remote communications session). In some embodiments, the meeting invitation 126 may be in the form of a generically formatted communication such as, for example, an email message, a Short Message Service (SMS) message (e.g., a “text message”), or a persistent chat type message (e.g., a MICROSOFT TEAMS chat message). In such embodiments, the system 100 may analyze content of the generically formatted communication using Natural Language Processing techniques in order to determine that the generically formatted communication is a meeting invitation 126 and also to parse out relevant aspects of the newly identified meeting invitation 126.

For purposes of the present discussion of FIG. 1, presume that the relevant aspects of the meeting invitation 126 that are identified by the system 100 include at least a meeting start time that is defined as a fourth time T₄ (which is prior to the fifth time T₅ at which the user manually scheduled the alarm signal to go off). Specifically, presume that the fourth time T₄ at which the user is being requested to attend a meeting is 6:30 AM—1 hour prior to the fifth time T₅ at which the alarm is scheduled to wake the user and 2 hours prior to the scheduled work hours associated with the user account.

The system 100 may then utilize the relevant aspects of the meeting invitation 126 to determine whether the meeting invitation 126 meets the alarm update criteria 110. Then, in response to determining that the particular meeting invitation does meet the alarm update criteria 110, the system 100 automatically updates the alarm settings 106 to prescribe an updated time for causing the alarm signal 128 to be generated by the client device 102. Here, the updated time is defined as a third time T₃ which is both: (i) subsequent to the second time T₂ at which the meeting invitation 126 was received, and (ii) prior to the fourth time T₄ at which the user is requested meeting is going to begin.

Ultimately, and as illustrated in FIG. 1, the system 100 causes the alarm signal 128 to be generated at the third time T₃. Here, the client device 102 is illustrated to be utilizing the I/O device 122 to generate the alarm signal 128 at the third time T₃. In some implementations, the I/O device 122 may include an audio speaker through which the alarm signal 128 is generated in accordance with some predefined audible alarm tone. Additionally, or alternatively, the I/O device 122 may include a light source (e.g., a light emitting diode “LED”) through which the alarm signal 128 is generated in accordance with some user selected flashing light pattern.

In some embodiments, the alarm update criteria 110 includes time-range definitions 112 that indicate specific time-ranges that, in order for the alarm update criteria 110 to be satisfied, certain aspects of a meeting invitation 126 are to fall within, fall outside of, be prior to, or be subsequent to. As a specific but non-limiting example, the time-range definitions 112 may define a first time-range that the meeting invitation 126 is to be received within in order for the alarm update criteria 110 to be satisfied. To illustrate this point, suppose that the user has specific preferences that the system 100 will monitor the incoming communications data 120 and potentially update the alarm settings 106 on his or her behalf only during hours nighttime hours that are designated for sleeping (e.g., 10 PM-6 AM). Under these circumstances, the user may define these “nighttime” hours within the time-range definitions 112 to cause the system 100 to act on his or her behalf only for meeting invitations 126 that are received during this time-range. Additionally, or alternatively, the time-range definitions 112 may define a second time-range prior to which a meeting start time (as indicated within the meeting invitation 126) is to be in order for the alarm update criteria 110 to be satisfied. To illustrate this point, suppose that the user has scheduled work hours during which he or she is typically physically present on an enterprise campus. Under these circumstances, the user may define these “scheduled work hours” within the time-range definitions 112 to cause the system 100 to act on his or her behalf only for meeting invitations 126 that request participation in meetings that will start prior to this time-range.

In some embodiments, the alarm update criteria 110 includes device mode data 114 that defines particular computing modes that, in order for the alarm update criteria 110 to be satisfied, the client device 102 is to be functioning in accordance with when the meeting invitation 126 is received. As a specific but non-limiting example, the device mode data 114 may define a reduced notification mode that may temporarily (i.e., so long as the client device 102 remains within the reduced notification mode) prevent the client device 102 from generating one or more predetermined notification types. For example, so long as the client device 102 remains functioning in accordance with the reduced notification mode, the client device 102 may be prevented from alerting the user (e.g., audibly, visually, and/or via haptic output such as vibration) in response to incoming communications such as, for example, phone calls, text messages, emails, meeting invitations, and so on.

In some embodiments, the alarm update criteria 110 includes alarm update permissions 116 which may indicate specific sending accounts from which the meeting invitation 126 is to originate in order for the alarm update criteria 110 to be satisfied. For example, the user may indicate one or more specific user accounts (e.g., which may be identified by email address or any other suitable identifying characteristic) that the system 100 is permitted to update the alarm settings 106 in the event that a meeting invitation 126 is received from one of these specific user accounts (of course so long as any other relevant alarm update criteria are also met). Additionally, or alternatively, the alarm update permissions 116 may indicate one or more time zones that the meeting invitation 126 is to be received in association with (e.g., sent from) in order for the alarm update criteria 110 to be satisfied. For example, the user may restrict the system 100 from acting on his or her behalf by automatically updating the alarm settings 110 unless the meeting invitation 126 is sent in association with a specifically defined time zone. As used herein, a meeting invitation 126 being sent in association with a specifically defined time zone may include the meeting invitation originating from the specifically defined time zone or including one or more meeting invitees that reside within specifically defined time zone. Additionally, or alternatively, the alarm update permissions 116 may indicate one or more geolocations that the meeting invitation 126 is to be received in association with (e.g., sent from) in order for the alarm update criteria 110 to be satisfied. For example, the user may restrict the system 100 from acting on his or her behalf by automatically updating the alarm settings 110 unless the meeting invitation 126 is sent from a user that resides in a specific country. Additionally, or alternatively, the alarm update permissions 116 may indicate one or more predefined date-ranges that the meeting invitation 126 is to be received during (or outside of) in order for the alarm update criteria 110 to be satisfied. For example, the user may restrict the system 100 from acting on his or her behalf by automatically updating the alarm settings 110 expect during some limited and specifically defined date-range (e.g., while a particular team member is traveling, during the lead up to a product launch event, etc.).

In some embodiments, the alarm update criteria 110 includes buffer time settings 110 that define an amount of buffer time to provide (if any) between a meeting start time that is indicated within a meeting invitation 126 and the updated time at which the alarm signal 128 is caused to go off. In particular, with respect to determining an updated time to trigger generation of the alarm signal 128, the system 100 may provide an appropriate amount of buffer time between the third time T₃ at which the updated alarm settings 106 cause the alarm signal 128 to be generated and the fourth time T₄ at which the user is requested to participate in the newly scheduled/requested meeting (e.g., as defined in the meeting invite 126). In some embodiments, the amount of buffer time may be a predefined and constant amount of time such as, for example, 1 hour, 45 minutes, 30 minutes, 15 minutes, no buffer time at all, or any other suitable amount of time. In such embodiments, upon determining that a meeting invitation 126 satisfies the alarm update criteria 110 and also identifying the meeting start time that is indicated within the meeting invitation 126, the system 100 may automatically update the alarm settings 106 to cause the client device 102 to generate the alarm signal 128 prior to the meeting start time by this predefined and constant amount of “buffer” time. For example, if such a “constant” buffer time is defined as 30 minutes and the identified meeting start time is 6:30 AM, then the system 100 may set the third time T₃ as 6:00 AM so that the user is woken (or otherwise alerted) 30 minutes prior to the start of the newly scheduled meeting.

In some embodiments, the amount of buffer time may be a variable amount of time that is dynamically determined and/or selected by the system 100 based on specifically identifiable and relevant aspects of the meeting invitation 126. One exemplary such aspect may be a meeting location that is defined within the meeting invitation 126. For example, the system 100 may extract location data from a “Location” field of the meeting invitation 126 to identify a particular location where the requested meeting is to take place. The identified location may be a physical location (e.g., a conference room, a street address, etc.) or a virtual location (e.g., a hyperlink to a teleconference session). Then, the system 100 may determine an appropriate amount of buffer time based on particular location where the requested meeting is to take place. For example, if the particular location is a conference room on an enterprise campus, the system 100 can update the alarm settings 106 to provide enough time (e.g., 1 hour) between the alarm signal 128 being triggered and the meeting start time to enable the user to wake up, get ready at home, and then commute to the enterprise campus in time for the requested meeting. In contrast, if the particular location where the meeting is to take place is virtual (such that the user can call in from any location including his or her home), the system 100 can update the alarm settings 106 to provide some lesser amount of time (e.g., 20 minutes) between the alarm signal 128 being triggered (e.g., at T₃) and the meeting start time (e.g., at T₄).

Another exemplary aspect of a meeting invitation 126 that may be relevant in determining an amount of buffer time may be the meeting start time that is extracted from the meeting invitation 126. To illustrate this point, suppose that traffic conditions are known to generally worsen as the morning progresses such that a projected commute time from the user's home address to an enterprise campus will increase as the morning progresses. Under these circumstances, if system 100 determines that that the meeting invitation 126 is requesting that the user participate in a meeting on the enterprise campus at 7:30 AM, then the system 100 may select an amount of buffer time that is based on the projected commute through “heavy” traffic to arrive on the enterprise campus just prior to (e.g., 10 minutes before) 7:30 AM. In contrast, if the system 100 determines that the meeting invitation 126 is requesting that the user participate in a meeting on the enterprise campus at 6:30 AM, then the system 100 may select a relatively lesser amount of buffer time that is based on the projected commute through “light” traffic to arrive on the enterprise campus just prior to (e.g., 10 minutes before) 6:30 AM.

These novel abilities of the system described herein provides a number of technical benefits over conventional alarm systems. For example, automatically updating user-defined alarm settings on behalf of a user in response to a meeting invitation being received outside predefined business hours reduces, or even eliminates, a need for the user to interact with a client device outside of the predefined business hours to timely react to such meeting invitations. For example, the technologies described herein may eliminate the need for the user to read meeting invitations received during night hours and react by manually updating his or her alarm settings accordingly to ensure attendance to newly scheduled early morning meetings. Thus, the technologies described herein provide at least the technical benefit of improving user interaction with a computing device. Such techniques can increase the efficiency of a computing system by reducing the number of times a user needs to interact with (e.g., by “waking”) a computing device to obtain relevant information from newly received meeting invitations.

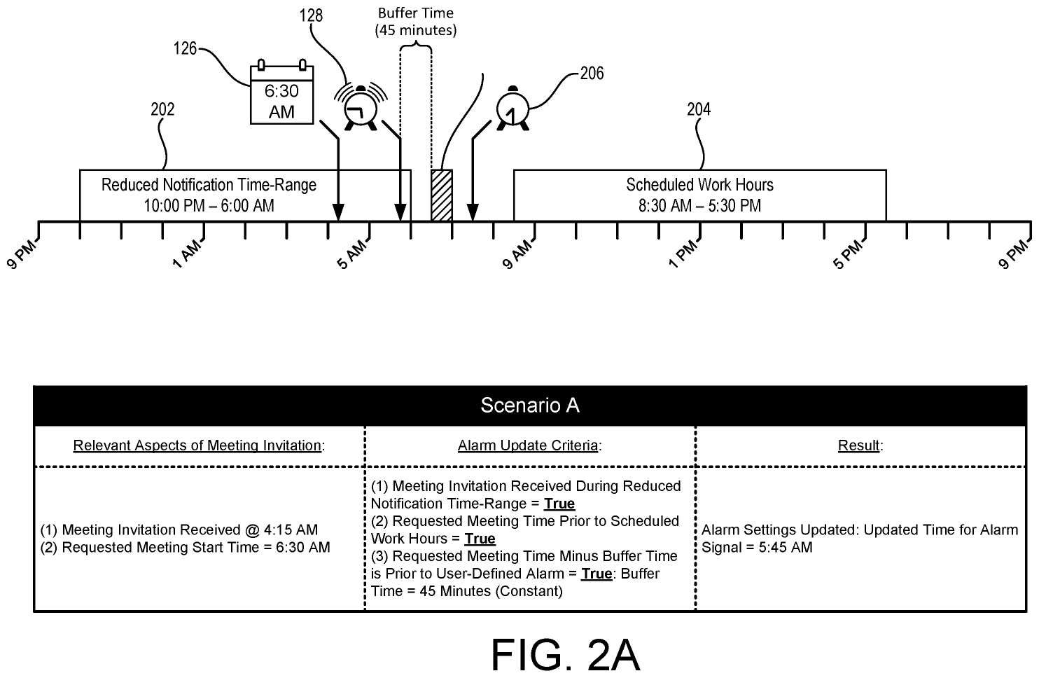

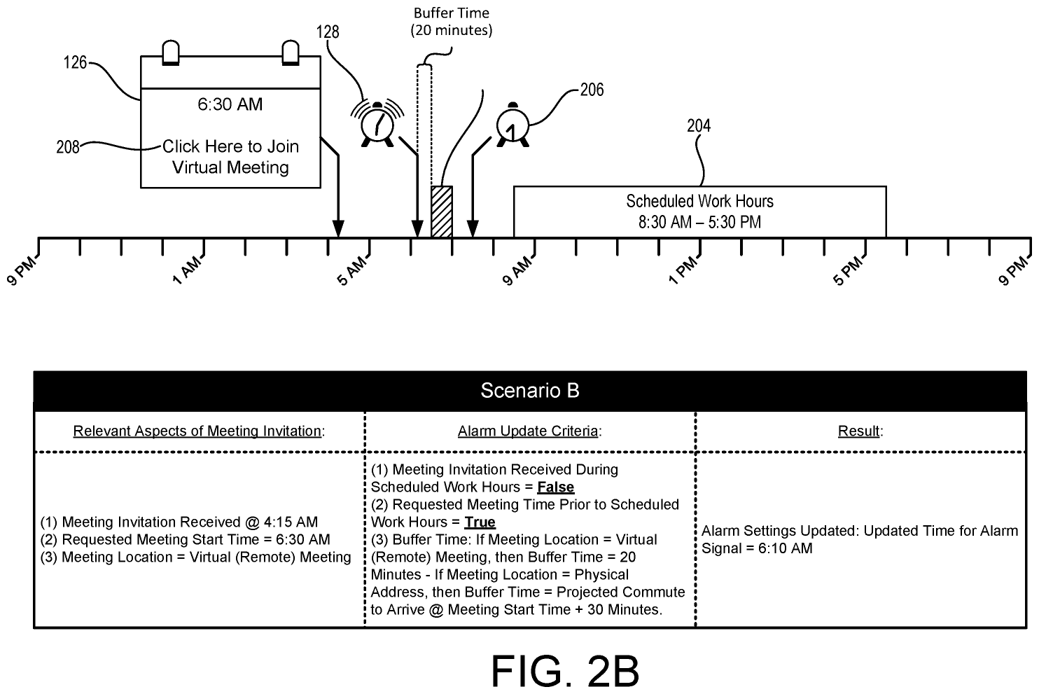

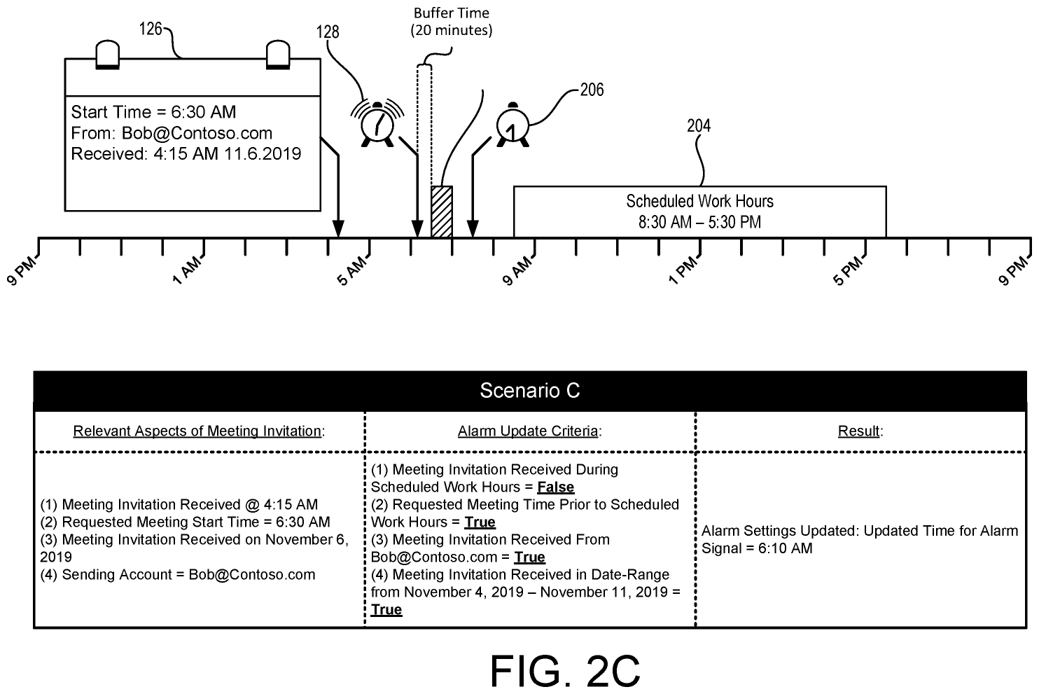

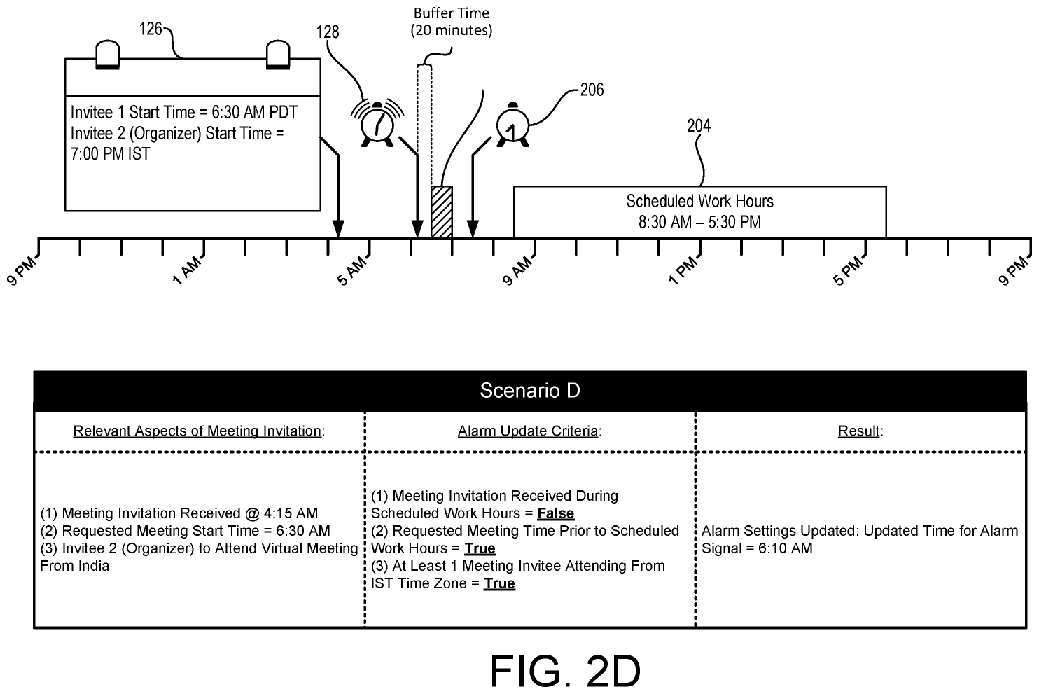

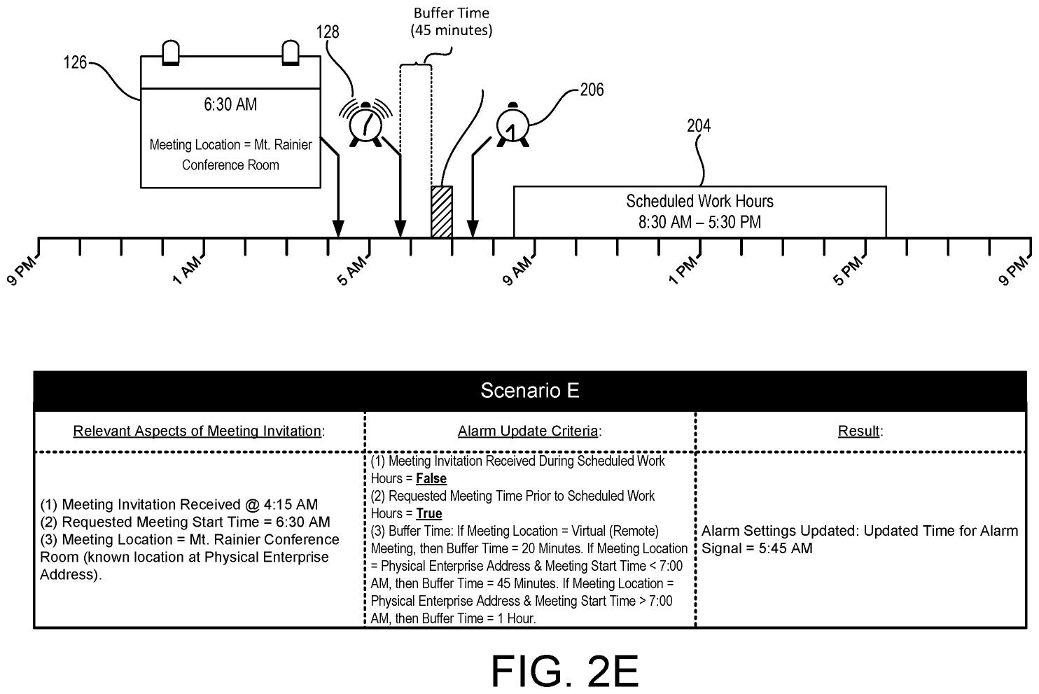

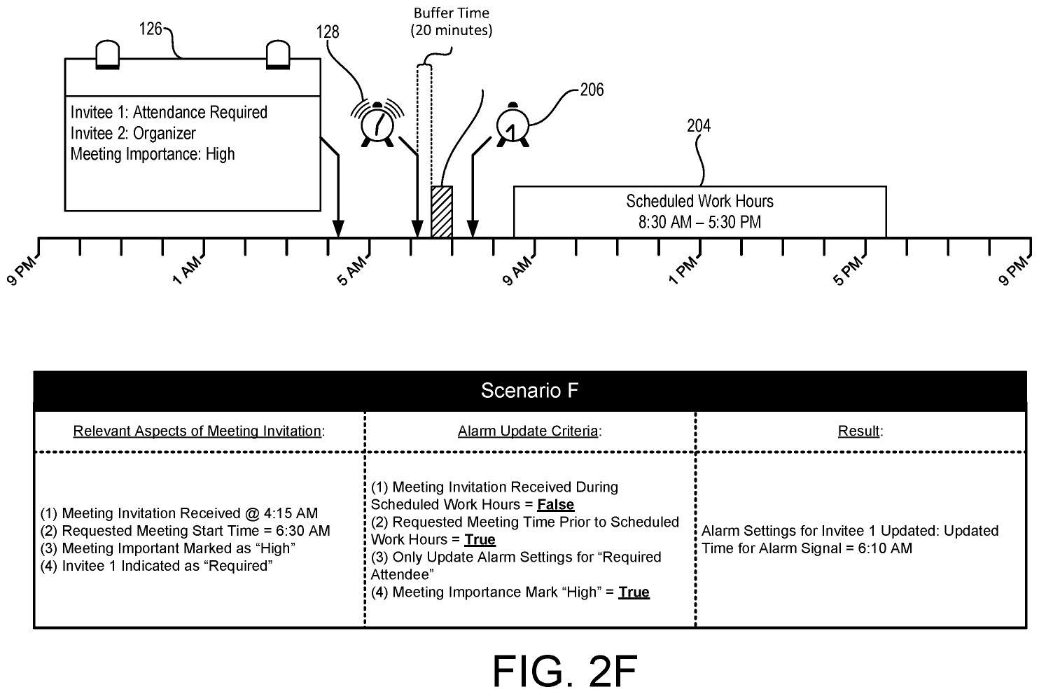

Turning now to FIG. 2A through FIG. 2F, example scenarios are illustrated in which alarm settings 106 are initially defined and then subsequently updated based on detection of a meeting invitation 126 being received under different factual circumstances. It should be appreciated that various aspects described in relation to one or more of FIGS. 2A through 2F may be omitted from the example scenario those aspects are described in relation to and/or combined with other example scenarios. Furthermore, the limited number of example scenarios described herein are for illustrative purposes only and are not to be construed as limiting. Performance of various aspects of the techniques described herein are contemplated under many other factual scenarios.

FIG. 2A illustrates a scenario in which the alarm settings 106 are updated on behalf of a user in response to a meeting invitation 126 being received during a first time-range 202 and requesting meeting participation that is to begin prior to a second time-range 204. As illustrated, a user-defined time 206 is initially set for an alarm signal to go off (e.g., an alarm signal “going off” refers to being generated by an output device such a speaker) some time prior to the second time-range 204. In the specifically illustrated scenario, the user-defined time 206 is set to 7:30 AM which is one hour and thirty minutes after the first time-range and one hour prior to the second time-range 204.

With respect to the time-ranges, in this example scenario, first time-range 202 corresponds to a reduced notification time-range that extends from 10:00 PM to 6:00 AM. In some embodiments, this reduced notification time-range may be a time period during which a client device 102 (that is to ultimately generate the alarm signal) is set to operate within a reduced notification mode that temporarily prevents the client device 102 from disturbing the user with various notifications. Exemplary reduced notification modes include, but are not limited to, the “Do Not Disturb” mode that is commonly provided for in various mobile device operating systems such as the “iOS” operating system by APPLE INC. and/or the ANDROID mobile operating system. In some implementations, the first time-range is a pre-scheduled time range during which the client device 102 is caused to temporarily operate within a particular mode such as the aforementioned reduced notification mode. In some implementations, the first time-range may be an ad-hoc time-range that begins when the user manually switches the client device 102 into a particular mode and later ends when the user manually switches the client device 102 out of the particular mode. Thus, an ad-hoc time-range may be manually created by a user for some particular purpose (e.g., to prevent disturbances) as desired. Also, in the illustrated scenario, the second time-range 204 corresponds to scheduled work hours that extend from 8:30 AM to 5:30 PM. In some embodiments, the second time-range 204 may be specifically defined within the user account data 104 and/or the time-range definitions 112. For example, various electronic calendar applications (e.g., MICROSOFT OUTLOOK, GOOGLE CALENDAR, etc.) provide users with an ability to define working hours in association with their electronic calendars. Based on these user-defined working hours, some calendar systems may automatically reply to people that attempt to schedule a meeting for a time-range that falls outside of these scheduled working hours.

In the illustrated scenario, the second time-range 204 is subsequent to the first time-range 202. For example, in the specifically illustrated but nonlimiting scenario, the first time-range 202 is shown to begin at 10 PM on a particular day and extend until 6 AM on the following day (e.g., this first time-range 202 crosses midnight). Then, after this first time-range 202 has ended, the second time-range 204 is shown to begin at 8:30 AM and then end at 5:30 PM on that following day on which the first time-range 202 ended. Thus, it can be appreciated that even though the time of 10 PM at which the first time-range 202 begins is later than 5:30 PM at which the second time-range 204 ends, the second time-range 204 is subsequent to the first time-range 204 since the first time-range 202 begins at 10 PM on the day before the second time-range 204 begins. For example, 10 PM on a particular day (e.g., Dec. 2, 2019) is prior to 5:30 PM on the next day (e.g., Dec. 3, 2019).

As illustrated, various relevant aspects of the meeting invitation 126 are identified by the system 100 by, for example, parsing predefined fields of the meeting invitation and/or analyzing the meeting invitation 126 using Natural Language Processing (NPL) techniques. Here, a first relevant aspect is that the meeting invitation 126 is a specific time at which the meeting invitation 126 is received within the incoming communications data 120. In the specifically illustrated scenario, the meeting invitation 126 is received at 4:15 AM which falls within the first time-range 202 during which the client device 102 is set to operate in accordance with the reduced notification mode. It can be appreciated that by virtue of having specifically set the client device 102 into an operational mode to limit disturbances, it may be undesirable to produce a notification that would disturb the user at 4:15 AM (e.g., since the user is likely asleep). Furthermore, a second relevant aspect is a meeting start time that is being requested within the meeting invitation 126. In the specifically illustrated scenario, the meeting start time that is being requested within the meeting invitation 126 is 6:30 AM, which is prior to the second time-range 204. It can be appreciated that by virtue of the requested meeting start time being prior to when the user is scheduled to begin work, there is a strong possibility that the user will not even become aware of the meeting invitation 126 until after the requested meeting time has passed. Furthermore, in this specific example, the requested meeting time of 6:30 AM is even prior to the user-defined time of 7:30 AM at which the alarm signal is initially scheduled to go off—thereby waking the user. Thus, the user may not even be awake at the requested meeting time of 6:30 AM. Using an existing alarm system which lacks functionality for monitoring incoming communications on behalf of a user and automatically (e.g., without user intervention) updating the alarm settings 106 when a meeting invitation 126 is received that meets one or more alarm update criteria, the user would be faced with the unfortunate choices of allowing the client device 102 to alert the user of the meeting invitation 126 when received or sleeping through the requested meeting.

In the illustrated example, however, the system 100 analyzes the meeting invitation 126 to identify the relevant aspects and then, in response to these aspects satisfying the alarm update criteria 110, automatically updates the alarm settings 106 on behalf of the user. Here, the alarm update criteria 110 include four criteria (or conditions) that define when and how to update the alarm settings 106. The first criterion is the meeting invitation 126 being received (e.g., within the incoming communications data 120) during the first time-range 202 (which in the illustrated example corresponds to the reduced notification time-range). Thus, in this example, the system 100 will potentially update the alarm settings 106 based on meeting invitations 126 that are received during this time-range but will not update the alarm settings 106 based on meeting invitations 126 that are received outside of this time-range. Here, the first criterion is satisfied because the meeting invitation 126 is received at 4:15 AM which is between 10:00 PM and 6:00 AM. The second criterion is the meeting start time that is being requested within the meeting invitation 126 being prior to the second time-range 204 (which in the illustrated example corresponds to the scheduled work hours). Here, the second criterion is satisfied because the requested meeting start time is 6:30 AM which is 2 hours prior to the second time-range 204. The third criterion is that the meeting start time being requested in the meeting invitation 126 minus a buffer time (which is predefined as 45 minutes) is prior to the user-defined time 206 at which the alarm signal is initially scheduled to go off. It can be appreciated that this third criterion may prevent the alarm settings 106 from being updated so that the alarm is triggered at a later time than defined by the user. Here, this third criterion is satisfied because the user-defined alarm time 206 is after 5:45 AM.

In scenario A, the relevant aspects of the meeting invitation 126 satisfy the alarm update criteria 110 and, therefore, the system 100 automatically updates the alarm settings 106 on behalf of the user. Here, the system 100 determines the updated time at which to cause the alarm signal 128 to be triggered by subtracting the buffer time of 45 minutes from the requested meeting start time of 6:30 AM. Thus, after being automatically updated by the system 100, the alarm settings 106 cause the alarm signal 128 to be generated by the client device 102 at 5:45 AM. It should be appreciated that a major technical benefit of these techniques is that the client device 102 can remain within the reduced notification mode to prevent unwanted disruptions during some period of time (e.g., through the night) while the system 100 concurrently analyzes meeting invitations received during this period of time and updates alarm settings 106 appropriately to cause the client device 102 to sound an alarm in time for the user to attend any relevant meetings that were scheduled during this period of time. This greatly improves user interaction with the client device 102 by reducing the number of user interactions needed for the user to alerted in time to attend newly scheduled meetings and by reducing the extent to which the client device 102 generates alerts or notifications that disturb the user.

In some embodiments, the alarm update criteria 110 may reference a single time-range and/or may define multiple methods for determining a buffer time depending on relevant aspects of the meeting invitation 126. FIG. 2B, in conjunction with FIG. 1, illustrates an example of such an embodiment. With respect to the relevant aspects of the meeting invitation 126, scenario B differs from scenario A in that the meeting invitation 126 includes meeting location data which indicates that the requested meeting is to be a “Virtual (Remote) Meeting.” For example, the system 100 may parse the meeting invitation 126 and identify a hyperlink 208 to a remote communications session such as, for example, a MICROSOFT TEAMS meeting in which two or more persons from around the world can communicate in real-time via a live audio/video stream. With respect to the alarm update criteria 110, scenario B differs from scenario A in that there is no specific criterion that the meeting invitation 126 be received during a user-defined time-period such as, for example, the reduced notification time-range. Instead, in scenario B the first criterion is that the meeting invitation 126 is received outside of the second time-range (e.g., the scheduled work hours). In particular, in order for the alarm update criterion to be satisfied in scenario B, the logical statement that the meeting invitation is received during scheduled work hours must be false. In some embodiments, although not as shown in scenario B, the alarm update criteria 110 may include a condition that the meeting invitation 126 is received within a threshold amount of time from a particular time-range. For example, an exemplary such condition may be that the meeting invitation 126 is received within 10 hours prior to the beginning of the scheduled work hours at 8:30 AM.

Moreover, in scenario B the alarm update criteria 110 provides for different methods of determining an amount of buffer time to set between the updated time at which the alarm signal 128 will be triggered and the meeting start time that is requested in the meeting invitation 126. In particular, the alarm update criteria provide that if the meeting invitation 126 indicates that the requested meeting is set to be a virtual meeting, then the buffer time is to be set to a predefined value of 20 minutes. In contrast, the alarm update criteria also provide that if the meeting invitation 126 instead indicates that the requested meeting is set to take place at a particular physical address (e.g., an enterprise campus), then the buffer time is to be set to a value that is dynamically determined based on a projected commute time to arrive at the particular physical address at (or slightly prior to, 5 minutes before) the meeting start time. Here, if the meeting location is defined as a physical address, then the buffer time will be set by the system 100 as the determined projected commute time plus an additional 30 minutes (e.g., to provide the user with time to wake up and begin the commute).

In scenario B, the relevant aspects of the meeting invitation 126 satisfy the alarm update criteria 110 for updating the alarm settings 110. Furthermore, the meeting location that is defined within the meeting invitation 126 indicates to the system 100 to utilize the predefined and constant buffer time (e.g., 20 minutes) in order to determine the updated time for the alarm signal to be triggered. Thus, the relevant aspects of the meeting invitation and the alarm update criteria of scenario B result in the system 100 updating the alarm settings to cause the alarm signal 128 to be triggered at the updated time of 6:10 AM.

In some embodiments, the alarm update criteria 110 define one or more criterion in association with specific sending accounts. For example, such criterion may limit the system 100 to updating the alarm settings 106 only under conditions where the meeting invitation 126 is received from these specific sending accounts. As another example, such criterion may prevent the system 100 from updating the alarm settings 106 under conditions where the meeting invitation 126 is received from a specific sending account. Additionally, or alternatively, the alarm update criteria 110 may define conditions in association with specific date ranges to limit the system 100 to updating the alarm settings 106 only if the meeting invitation is received on one or more specific dates. FIG. 2C, in conjunction with FIG. 1, illustrates an example of such an embodiment. With respect to the relevant aspects of the meeting invitation 126, scenario C differs from scenario A in that the meeting invitation 126 is received on a particular date (e.g., Nov. 6, 2019) and from a particular sending account (e.g., Bob@Contoso.com). With respect to the alarm update criteria, scenario C differs from scenario A in that the alarm update criterion being satisfied requires that the meeting invitation is sent from a specifically defined account and within a specifically defined date-range. As illustrated, the date that the meeting invitation 126 is received falls within the date-range of Nov. 4, 2019-Nov. 11, 2019 that is defined in the alarm update criteria. Furthermore, the sending account from which the meeting invitation 126 is sent matches the user account that is defined within the logical statement of criterion three. Therefore, in scenario C the relevant aspects of the meeting invitation 126 satisfy the alarm update criteria 110 for updating the alarm settings 110—which results in the system 100 automatically updating the alarm settings 106.

In some embodiments, the alarm update criteria 110 define specific geolocations and/or time zones that the meeting invitation 126 is to be sent in association with for the alarm update criteria 110 to satisfied. For example, the alarm update criteria 110 may limit the system 100 to updating the alarm settings 106 only if the meeting invitation 126 includes at least some invitees that are to attend the requested meeting while physically present within predefined geolocations and/or time zones. FIG. 2D, in conjunction with FIG. 1, illustrates an example of such an embodiment. With respect to the relevant aspects of the meeting invitation 126, scenario D differs from scenario A in that the meeting invitation 126 defines a list of invitees and location information indicating a geolocation and/or time zone where one or more of these invitees are expected to be during the meeting. With respect to determining a user's current and/or expected future location, it can be appreciated that some calendaring systems such as MICROSOFT OUTLOOK may determine location data of a user based on an IP address from which a user logs into his or her user account. In this way, these calendaring systems can determine a specific time zone within which a user is currently physically present when the meeting invitation 126 is transmitted. Then, the system 100 may operate under a presumption that the user will be within the identified time zone during the requested meeting. It can be appreciated that this is a reasonable assumption under various factual scenarios for implementing the techniques described herein because often a requested meeting start time will be merely a few (e.g., 6 or less) hours from when the meeting invitation 126 is sent. For purposes of scenario D, presume that Invitee 2 is the organizer whom generated and ultimately transmitted the meeting invitation 126 to Invitee 1. Further presume that, when the meeting invitation is sent to and/or received at the incoming communications data 120, Invitee 2 is currently physically present in the country India and that Invitee 1 is currently physically present in Seattle, Wash. Since the requested meeting start time is a mere 2 hours and 15 minutes after the time the meeting invitation 126 is sent, it is highly probable that the Invitees will still be in Seattle, Wash. and India when the meeting begins. With respect to the alarm update criteria, scenario C differs from scenario A in that the alarm update criterion being satisfied requires that at least one meeting invitee is expected to attend (e.g., call into) the meeting from the India Standard Time (IST) time zone. Therefore, in scenario D the relevant aspects of the meeting invitation 126 satisfy the alarm update criteria 110 for updating the alarm settings 110 - which results in the system 100 automatically updating the alarm settings 106.

In some embodiments, the alarm update criteria 110 define criterion related to determining an amount of buffer time based on a requested meeting start time. For example, the alarm update criterion 110 may cause the system 100 to select a first amount of buffer time if a requested meeting start time is prior to a particular time but to instead select a second amount of buffer time if the requested meeting start time is subsequent to the particular time. FIG. 2E, in conjunction with FIG. 1, illustrates an example of such an embodiment. With respect to the relevant aspects of the meeting invitation 126, scenario E differs from scenario A in that the meeting invitation 126 defines a meeting location as a specific physical location (e.g., a “Mt. Rainer Conference Room” that is known by the system 100 to be at a physical enterprise address). With respect to the alarm update criteria 110, scenario E differs from scenario A in that the alarm update criterion indicate multiple different buffer times for the system 100 to select from (and to use to determine the updated time for the alarm to be triggered) depending on when and/or where the requested meeting is to occur. In this specifically illustrated factual scenario, the logical statement of “If Meeting Location=Physical Enterprise Address & Meeting Start Time<7:00 AM” is TRUE and, therefore, the system 100 uses a buffer time value of 45 minutes to calculate the updated meeting time. Therefore, in scenario E the system automatically updates the alarm settings to cause the alarm signal to go off at 5:45 AM.

In some embodiments, the alarm update criteria 110 may define criterion related to determining whether to update alarm settings based on an importance level indicated for a meeting invitation. For example, the alarm update criterion 110 may limit the system 100 to updating the alarm settings only to situations in which the meeting invitation 126 indicates that the requested meeting is of “High” importance. Additionally, or alternatively, the alarm update criteria 110 may define criterion related to determining whether to update alarm settings for one or more individual users (which may be a subset of meeting invitees) based on an indication of the importance of those individual users attending the meeting. For example, the alarm update criterion 110 may limit the system 100 to updating the alarm settings only for specific invitees whose attendance for the meeting is designated as “Required.” FIG. 2F, in conjunction with FIG. 1, illustrates an example of such an embodiment. With respect to the relevant aspects of the meeting invitation 126, scenario F differs from scenario A in that the meeting invitation 126 defines a meeting importance as “High” and also designates the Invitee 1 as being a required attendee. With respect to the alarm update criteria 110, scenario F differs from scenario A in that the alarm update criterion restrict the system 100 to updating alarm settings only for required attendees and also limits the system 100 to updating alarm settings only in response to meeting invitations that indicate a predefined importance level of the requested meeting (e.g., “High,” “Medium,” or any other suitable importance level). Therefore, in scenario F the relevant aspects of the meeting invitation 126 satisfy the alarm update criteria 110 for updating the alarm settings 110—which results in the system 100 automatically updating the alarm settings 106.

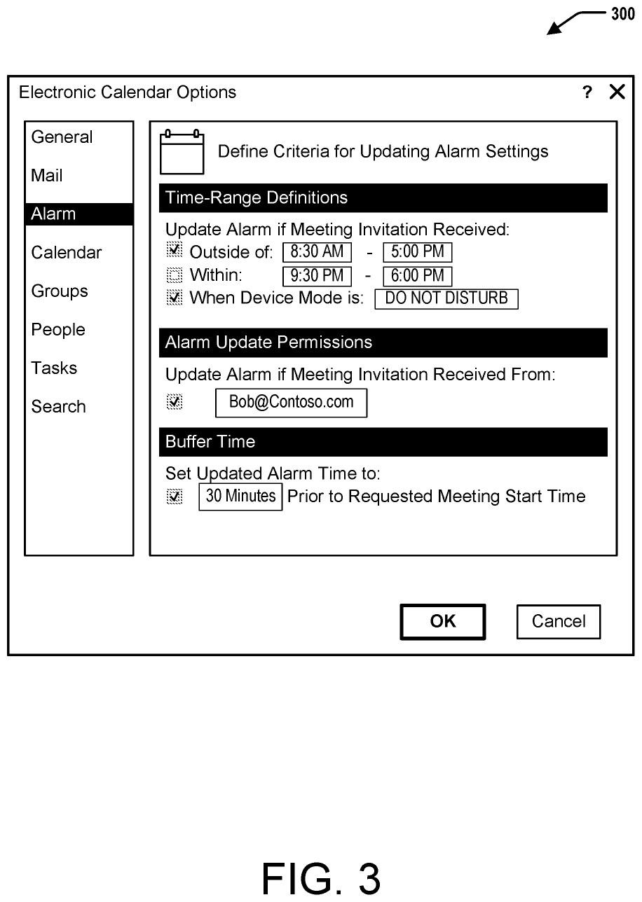

Turning now to FIG. 3, illustrated is an exemplary graphical user interface (GUI) 300 that may be displayed to enable a user to define alarm update criterion in association with one or more particular user accounts. In some embodiments, an individual user may define alarm update criterion that is uniquely customized for his or her user account. Additionally, or alternatively, a user with some level of administrative authority over one or more user accounts may define and apply alarm update criterion across multiple user accounts.

As illustrated, the GUI 300 represents a situation in which a user has defined alarm update criterion which limit the system 100 to updating the alarm setting to specific factual circumstances. As further illustrated, the GUI 300 also represents a situation in which the user has defined a buffer time for the system 100 to utilize to determine an updated alarm time for an alarm signal to be triggered. Here, the alarm update criteria include three separate conditions or individual criterion which the relevant aspects of a meeting invitation are to satisfy in order for the system 100 respond by automatically updating alarm settings on a user's behalf. The first criterion is that the meeting invitation is received outside of a first time-range of 8:30 AM through 5:00 PM. The second criterion is that the meeting invitation is received during a second time-range which is defined as any time that a client device 102 is within a particular device mode (e.g., a “Do Not Disturb” Mode). The third criterion is that the meeting invitation is received from a predefined user account (e.g., Bob@Contoso.com). Thus, by defining the three criteria as shown in FIG. 3, a user can provide highly specific instructions to the system 100 as to when the user-defined alarm time may be automatically updated on behalf of the user (e.g., without input from the user). Moreover, the alarm update criteria include another “fourth” criterion that defines how the alarm settings are to be updated. In particular, the GUI 300 represents a situation in which the user is defining alarm update criteria that instruct the system 100 to set an updated time for the alarm at 30 minutes prior to the meeting start time that is being requested in the meeting invitation—of course assuming any other relevant criterion are satisfied.

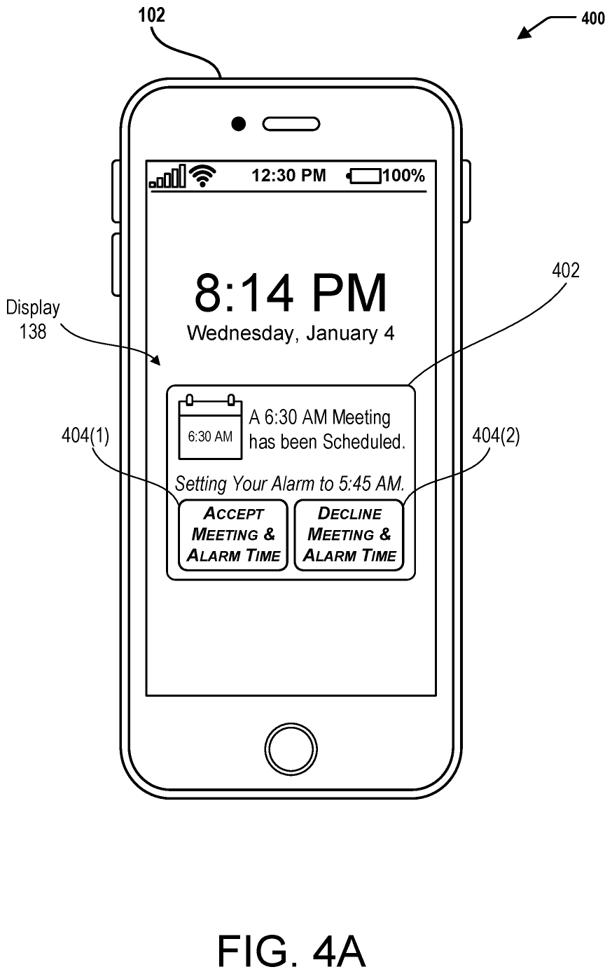

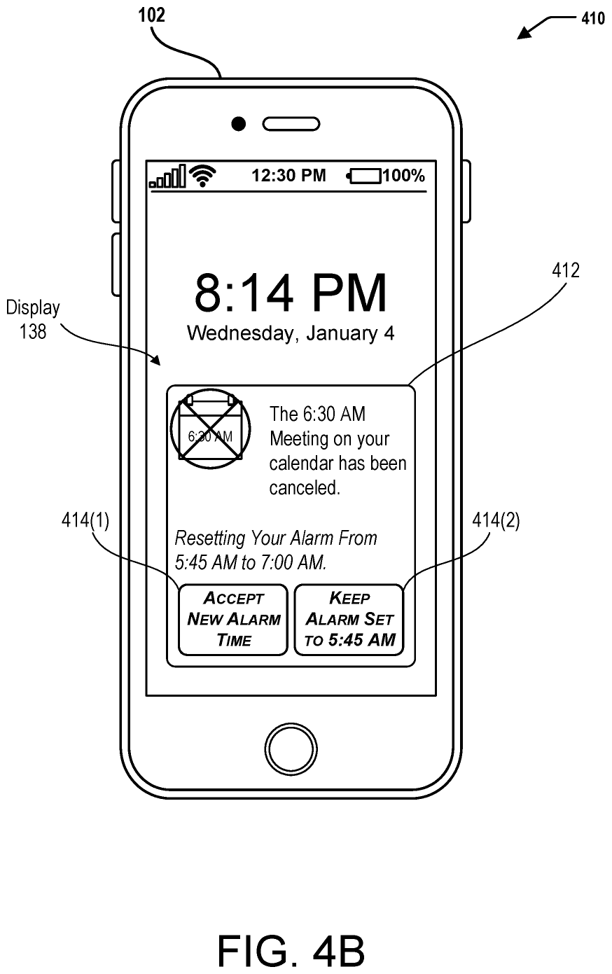

Turning now to FIG. 4A, illustrated is an exemplary GUI 400 that includes a notification 402 to inform a user of alarm settings being automatically updated in response to a meeting invitation being received. In the specifically illustrated embodiment, the GUI 400 exposes the notification 402 in response to a meeting invitation being received at 8:14 PM (e.g., after scheduled work hours for particular day) that is inviting the user to participate in a meeting at 6:30 AM the following morning (e.g. prior to scheduled work hours for the next day). Thus, under these circumstances it can be appreciated that unless the user checks his or her incoming communications (e.g., emails and/or calendar invites) outside of scheduled work hours, the user will likely not timely be informed of the meeting without deploying the techniques described herein.

In some embodiments, the notification 402 may include one or more user interface elements 404 to enable the user to select between various actions to take with regard to the newly received meeting invitation. In the specifically illustrated but non-limiting embodiment, the notification 402 includes a first user interface element 404(1) that enables the user to both accept the meeting invitation and also the updated alarm time of 5:45 AM. Thus, by providing a single user input (i.e., by selecting the first user interface element 404(1)) the user is able to simultaneously accept the updated alarm time and cause an acceptance reply to be transmitted in association the meeting invitation. As illustrated, the notification 402 further includes a second user interface element 404(2) that enables the user to both decline the meeting invitation and also the updated alarm time of 5:45 AM. Thus, by providing a single user input (i.e., by selecting the second user interface element 404(2)) the user is able to simultaneously cancel the updated alarm time and cause a rejection reply to be transmitted in association the meeting invitation.

Turning now to FIG. 4B, illustrated is an exemplary GUI 410 that includes a notification 412 to inform a user of alarm settings being automatically updated in response to a meeting cancellation being received. In the specifically illustrated example, the GUI 410 exposes the notification 412 in response to a meeting cancellation being received at 8:14 PM (e.g., after scheduled work hours for a particular day) that is cancelling a meeting that the user was scheduled to participate in at 6:30 AM the following morning. For example, the user may have already received a meeting invitation that invited him or her to participate in the 6:30 AM meeting. Then, the user may have accepted the meeting (e.g., causing it to be added to the calendar) and also manually updated alarm settings to set an alarm for 5:45 AM—providing a 45 minute buffer for the user to be woken by the alarm and attend the meeting. Here, it can be appreciated that since the meeting cancellation was received after scheduled work hours there is a significant probability that the user will not be informed about the meeting cancellation without deploying the techniques described herein (e.g., since many users seldom, if ever, check their email and/or calendar invites outside of scheduled work hours).

In some embodiments, the notification 412 may include one or more user interface elements 404 to enable the user to select between various action to take with regard to the newly received meeting cancellation. In the specifically illustrated but non-limiting embodiment, the notification 412 includes a first user interface element 414(1) that enables the user to accept a new alarm time of 7:00 AM while simultaneously cancelling the previously set 5:45 AM alarm time. As illustrated, the notification 412 further includes a second user interface element 414(2) that enables the user to decline the updated alarm time of 7:00 AM and to keep his or her alarm set to 5:45 AM.

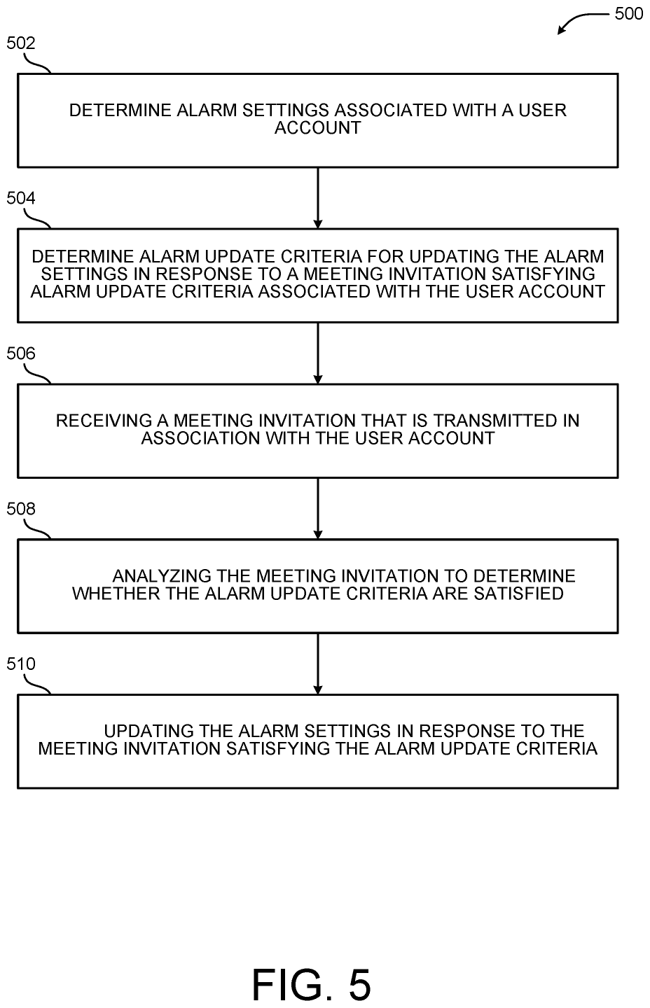

FIG. 5 is a diagram illustrating aspects of a routine 500 for updating alarm settings associated with a user account in response to a meeting invitation that satisfies one or more alarm update criteria being received in association with the user account. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

At block 502, the system 100 determines alarm settings associated with a user account. For example, the system 100 may access the alarm settings 106 that are stored on the client device 102 that is associated with the user account data 104. The alarm settings 106 may prescribe a user-defined time for causing an alarm signal to be generated by the client device 102. Stated plainly, this user-defined time may simply be a specific time which the user manually defines prior to going to bed and which the client device 102 will sound an alarm signal to wake the user.

At block 504, the system 100 determines alarm update criteria for updating the alarm settings in response to a meeting invitation being received under certain factual circumstances. Stated plainly, the alarm update criteria may define when and how the system 100 is to update the alarm settings 106 in response to a meeting invitation being received in association with a user account. For example, the alarm update criteria may define one or more specific conditions under which the system 100 is to update the user-defined alarm time. Furthermore, the alarm update criteria may define an amount of buffer time to set between the updated alarm time and the requested meeting start time.

At block 506, the system 100 receives a meeting invitation that is transmitted in association with the user account. For example, the system 100 may monitor incoming communications data such as, for example, an email inbox that corresponds to the user account.

At block 508, the system 100 analyzes the meeting invitation to determine whether the alarm update criteria are satisfied. For example, the system 100 may analyze an incoming communication to determine whether it is a meeting invitation. Furthermore, the system 100 can extract relevant aspects of the meeting invitation for use in determining whether the alarm update criteria are satisfied.

At block 510, the system 100 updates the alarm settings in response to the meeting invitation satisfying the alarm update criteria. For example, as described in relation to FIGS. 2A-2F, the system may determine when relevant aspects of a meeting invitation satisfy one or more specific alarm update criterion that have been defined by a user for his or her user account. Then, the system may further determine at what time the updated alarm is to go off due to receiving the meeting invitation. Thus, upon defining alarm update criteria associated with a user account, a user can deploy the techniques described herein to cause the system to monitor incoming communications outside of predefined business hours and, ultimately to automatically update alarm settings if a meeting invitation is received that satisfies certain criteria.

In some implementations, updating the alarm settings in response to the meeting invitation satisfying the alarm update criteria may include transmitting a communication to an alarm application that is native to an operating system of a device. The communication may include alarm update data indicating how to update the time of an alarm that has been set on the device. To illustrate this point, consider a typical smart phone (e.g., an APPLE iPHONE) that has a native operating system (e.g., APPLE iOS version 13) which includes an alarm application as a native application. Here, the communication including the alarm update data may be transmitted from the alarm update engine 108 to the native operating system and/or the “native” alarm application to update the alarm settings of the “native” alarm application. Additionally, or alternatively, updating the alarm settings in response to the meeting invitation satisfying the alarm update criteria may include scheduling a notification to be exposed by a non-native application (e.g., a third party calendar and/or email application such as, for example, MICROSOFT OUTLOOK installed on a iOS-based APPLE iPHONE) at the updated alarm time. It can be appreciated that such embodiments may be beneficial under circumstances where the non-native application that is implementing the alarm update engine 108 is unable to directly manipulate alarm settings of a native alarm.

It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or m ore device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

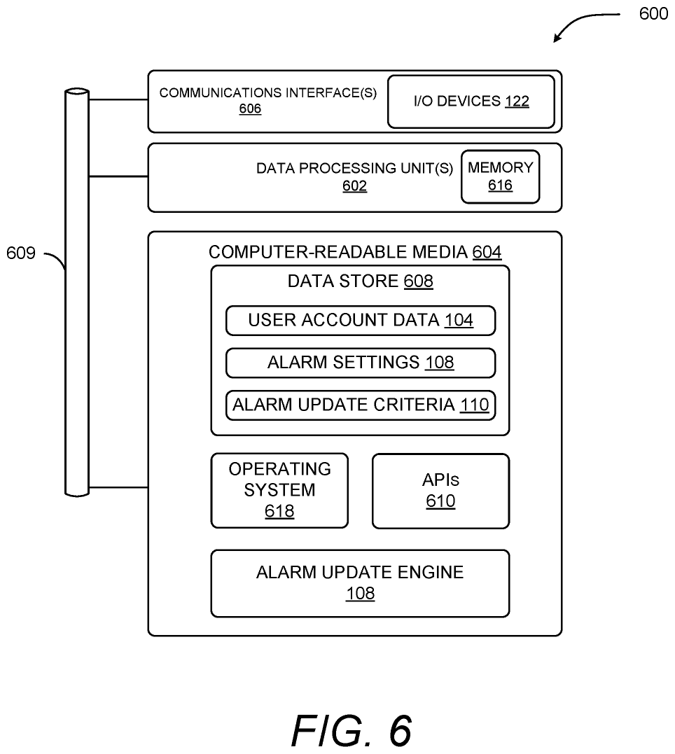

FIG. 6 illustrates a diagram that shows various components of an example device 600 (also referred to herein as a “computing device”) configured to implement various operations described herein. As illustrated, the device 600 includes one or more data processing unit(s) 602, computer-readable media 604, and communication interface(s) 606. The components of the device 600 are operatively connected, for example, via a bus 609, which may include one or more of a system bus, a data bus, an address bus, a PCI bus, a Mini-PCI bus, and any variety of local, peripheral, and/or independent buses.

As utilized herein, data processing unit(s), such as the data processing unit(s) 602 may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“AS SPs”), System-on-a-Chip Systems (“SOCs”), Complex Programmable Logic Devices (“CPLDs”), etc.

As utilized herein, computer-readable media, such as computer-readable media 604 may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 606 may represent, for example, network interface controllers (“NICs”) or other types of transceiver devices to send and receive communications over a network. Furthermore, the communication interface(s) 606 may include one or more input/output (I/O) devices 122 such as, for example, a speaker for generating an alarm signal, a touch screen for receiving user input that defines alarm update criteria, and so on.

In the illustrated example, computer-readable media 604 includes a data store 608. In some examples, the data store 608 includes data storage such as a database, data warehouse, or other type of structured or unstructured data storage. In some examples, the data store 608 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 608 may store data for the operations of processes, applications, components, and/or modules stored in computer-readable media 604 and/or executed by data processing unit(s) 602 and/or accelerator(s). For instance, in some examples, the data store 608 may store user account data 104, alarm settings 108, and alarm update criteria 110 as described herein. In this example, the computer-readable media 604 also includes an operating system 618 and application programming interface(s) 610 (APIs) configured to expose the functionality and the data of the device 600 to other devices. Furthermore, the computer-readable media 604 include instructions (e.g., computer code) for implementing the alarm update engine 108 as described herein.

The presently disclosed technologies are believed to be applicable to a variety of systems and approaches for presenting a status indicator within a first digital context in response to a user interacting with a data object within a second digital context. Furthermore, the presently disclosed technologies are believed to be applicable to a variety of systems and approaches for enabling a recipient of the status indicator to initiate communications, directly from the first digital context, with the user that is interacting with the data object within the second digital context. Aspects of the disclosed technologies are described in the context of a unified communications platform. While the presently disclosed technologies are not necessarily limited to this context, an appreciation of various aspects of the presently disclosed technologies is best gained through a discussion of examples in this specific context. However, the presently disclosed technologies may also be deployed in scenarios that do not include a unified communications platform such as, for example, file synchronization platforms (e.g., ONEDRIVE, DROPBOX, etc.) file directory platforms (e.g., WINDOWS, MacOS, etc.) photo previews, SharePoint, and so on. It should also be appreciated that many variations and modifications may be made to the above-described examples, the elements of which are to be understood as being among other acceptable examples. All such modifications and variations are intended to be included herein within the scope of this disclosure and protected by the following claims.

### EXAMPLE CLAUSES

Example Clause A, a computer-implemented method, comprising: determining one or more alarm settings that prescribe at least a user-defined time for causing an alarm signal to be generated by a client device that is associated with a user account; determining alarm update criteria for updating the one or more alarm settings in response to one or more meeting invitations being received in association with the user account, the alarm update criteria including at least: the one or more meeting invitations being received during a first time-range, and the one or more meeting invitations requesting meeting participation that is to begin prior to a second time-range that indicates scheduled work hours associated with the user account, wherein the first time-range ends prior to a start time of the second time-range; receiving, during the first time-range, a particular meeting invitation that is addressed to the user account and that defines a meeting start time that is prior to the second time-range; and in response to determining that the particular meeting invitation meets the alarm update criteria, updating the one or more alarm settings to prescribe at least an updated time for causing the alarm signal to be generated by the client device prior to the user-defined time.

Example Clause B, the computer-implemented method of Example Clause A, wherein the second time-range is a reduced notification time-range that is prescribed in association with the client device to temporarily prevent the client device from generating one or more predetermined notification types.

Example Clause C, the computer-implemented method of any one of Example Clauses A through B, wherein determining that the particular meeting invitation meets the alarm update criteria includes: identifying a sending account from which the particular meeting invitation originated; and determining that alarm update permissions, that are defined in association with the user account, permit the updating of the one or more alarm settings in response to the one or more meeting invitations being received from the sending account.

Example Clause D, the computer-implemented method of any one of Example Clauses A through C, wherein determining that the particular meeting invitation meets the alarm update criteria includes: identifying at least one time zone associated with the particular meeting invitation; and determining that alarm update permissions, that are defined in association with the user account, permit the updating of the one or more alarm settings in response to the one or more meeting invitations being received in association with the at least one time zone.

Example Clause E, the computer-implemented method of any one of Example Clauses A through D, wherein determining that the particular meeting invitation meets the alarm update criteria includes: identifying at least one geolocation associated with the particular meeting invitation; and determining that alarm update permissions, that are defined in association with the user account, permit the updating of the one or more alarm settings in response to the one or more meeting invitations being received in association with the at least one geolocation.

Example Clause F, the computer-implemented method of any one of Example Clauses A through E, wherein alarm update permissions associated with the user account prescribe a predefined date-range during which to permit the updating of the one or more alarm settings, and wherein the alarm update criteria further include the one or more meeting invitations being received during the predefined date-range.

Example Clause G, the computer-implemented method of any one of Example Clauses A through F, wherein the updated time is defined based at least in part on an amount of buffer time measured backwards from the meeting start time.

Example Clause H, the computer-implemented method of Example Clause G, wherein the amount of buffer time is determined based on the meeting start time.

Example Clause I, the computer-implemented method of Example Clause G, wherein the amount of buffer time is determined based on location data that is included within the particular meeting invitation.

Example Clause J, a system, comprising: at least one processor; and at least one memory in communication with the at least one processor, the at least one memory having computer-readable instructions stored thereupon that, when executed by the at least one processor, cause the at least one processor to: determine alarm settings that define a first time for causing an alarm signal to be generated by a client device that is associated with a user account; receive a meeting invitation that is addressed to the user account; determine that the meeting invitation satisfies alarm update criteria associated with the user account based at least in part on a meeting start time, that is defined in the meeting invitation, being prior to a predefined time-range that is associated with the user account; and responsive to the meeting invitation satisfying the alarm update criteria, update the alarm settings to define a second time, that is prior to the first time, for causing the alarm signal to be generated by the client device, wherein the second time is determined based at least in part on buffer time settings associated with the user account.

Example Clause K, the system of Example Clause J, wherein determining that the meeting invitation satisfies the alarm update criteria associated with the user account is further based on the meeting invitation being received while the client device is operating in accordance with a predetermined operational mode.

Example Clause L, the system of any one of Example Clauses J through K, wherein determining that the meeting invitation satisfies the alarm update criteria associated with the user account is further based on the meeting invitation being received while the client device is operating in accordance with a reduced notification mode.

Example Clause M, the system of any one of Example Clauses J through L, wherein determining that the meeting invitation satisfies the alarm update criteria associated with the user account is further based on the meeting invitation indicating at least one invitee that is associated with a predetermined time zone.

Example Clause N, the system of any one of Example Clauses J through M, wherein the computer-readable instructions further cause the at least one processor to: determine location data associated with the meeting invitation; and determine, based on the buffer time settings and the location data, an amount of buffer time to prescribe between the second time and the meeting start time.

Example Clause O, the system of any one of Example Clauses J through N, wherein the amount of buffer time is determined based at least in part on a projected commute to a physical location associated with the meeting invitation.

Example Clause P, the system of any one of Example Clauses J through O, wherein the computer-readable instructions further cause the at least one processor to: determine an amount of buffer time based on the meeting start time; and determine the second time based on the amount of buffer time.

Example Clause Q, a system comprising: means for determining alarm settings that define a first time for causing an alarm signal to be generated by a client device that is associated with a user account; means for receiving a meeting invitation that is addressed to the user account; means for determining that the meeting invitation satisfies alarm update criteria associated with the user account based at least in part on a meeting start time, that is defined in the meeting invitation, being prior to a predefined time-range that is associated with the user account; and means for updating the alarm settings to define a second time for causing the alarm signal to be generated by the client device responsive to the meeting invitation satisfying the alarm update criteria.

Example Clause R, the system of Example Clause Q, further comprising: means for receiving user input that defines the alarm update criteria in association with the user account, the user input defining at least one of: specific user accounts, specific geolocations, specific time zones, or specific date ranges.

Example Clause S, the system of any one of Example Clauses Q through R, wherein determining that the meeting invitation satisfies the alarm update criteria includes: identifying a sending account associated with the meeting invitation; and determining that alarm update permissions, that are defined in association with the user account, permit the updating of the alarm settings in response to the meeting invitation being received from the sending account.

Example Clause T, the system of any one of Example Clauses J through S, further comprising means for determining an amount of buffer time based on at least one of the meeting start time indicated within the meeting invitation or location data included within the meeting invitation.

### CONCLUSION

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A computer-implemented method, comprising:
determining one or more alarm settings that prescribe at least a user-defined time for causing an alarm signal to be generated by a client device that is associated with a user account;
determining alarm update criteria for updating the one or more alarm settings in response to one or more meeting invitations being received in association with the user account, the alarm update criteria including at least:
the one or more meeting invitations being received during a first time-range, and
the one or more meeting invitations requesting meeting participation that is to begin prior to a second time-range that indicates scheduled work hours associated with the user account, wherein the first time-range ends prior to a start time of the second time-range;
receiving, during the first time-range, a particular meeting invitation that is addressed to the user account and that defines a meeting start time that is prior to the second time-range; and
in response to determining that the particular meeting invitation meets the alarm update criteria, updating the one or more alarm settings to prescribe at least an updated time for causing the alarm signal to be generated by the client device prior to the user-defined time.

2. The computer-implemented method of claim 1, wherein the second time-range is a reduced notification time-range that is prescribed in association with the client device to temporarily prevent the client device from generating one or more predetermined notification types.

3. The computer-implemented method of claim 1, wherein determining that the particular meeting invitation meets the alarm update criteria includes:
identifying a sending account from which the particular meeting invitation originated; and
determining that alarm update permissions, that are defined in association with the user account, permit the updating of the one or more alarm settings in response to the one or more meeting invitations being received from the sending account.

4. The computer-implemented method of claim 1, wherein determining that the particular meeting invitation meets the alarm update criteria includes:
identifying at least one time zone associated with the particular meeting invitation; and
determining that alarm update permissions, that are defined in association with the user account, permit the updating of the one or more alarm settings in response to the one or more meeting invitations being received in association with the at least one time zone.

5. The computer-implemented method of claim 1, wherein determining that the particular meeting invitation meets the alarm update criteria includes:
identifying at least one geolocation associated with the particular meeting invitation; and
determining that alarm update permissions, that are defined in association with the user account, permit the updating of the one or more alarm settings in response to the one or more meeting invitations being received in association with the at least one geolocation.

6. The computer-implemented method of claim 1, wherein alarm update permissions associated with the user account prescribe a predefined date-range during which to permit the updating of the one or more alarm settings, and wherein the alarm update criteria further include the one or more meeting invitations being received during the predefined date-range.

7. The computer-implemented method of claim 1, wherein the updated time is defined based at least in part on an amount of buffer time measured backwards from the meeting start time.

8. The computer-implemented method of claim 7, wherein the amount of buffer time is determined based on the meeting start time.

9. The computer-implemented method of claim 7, wherein the amount of buffer time is determined based on location data that is included within the particular meeting invitation.

10. A system, comprising:
at least one processor; and
at least one memory in communication with the at least one processor, the at least one memory having computer-readable instructions stored thereupon that, when executed by the at least one processor, cause the at least one processor to:
determine alarm settings that define a first time for causing an alarm signal to be generated by a client device that is associated with a user account;
receive a meeting invitation that is addressed to the user account;
determine that the meeting invitation satisfies alarm update criteria associated with the user account based at least in part on a meeting start time, that is defined in the meeting invitation, being prior to a predefined time-range that is associated with the user account; and
responsive to the meeting invitation satisfying the alarm update criteria, update the alarm settings to define a second time, that is prior to the first time, for causing the alarm signal to be generated by the client device, wherein the second time is determined based at least in part on buffer time settings associated with the user account.

11. The system of claim 10, wherein determining that the meeting invitation satisfies the alarm update criteria associated with the user account is further based on the meeting invitation being received while the client device is operating in accordance with a predetermined operational mode.

12. The system of claim 10, wherein determining that the meeting invitation satisfies the alarm update criteria associated with the user account is further based on the meeting invitation being received while the client device is operating in accordance with a reduced notification mode.

13. The system of claim 10, wherein determining that the meeting invitation satisfies the alarm update criteria associated with the user account is further based on the meeting invitation indicating at least one invitee that is associated with a predetermined time zone.

14. The system of claim 10, wherein the computer-readable instructions further cause the at least one processor to:
determine location data associated with the meeting invitation; and
determine, based on the buffer time settings and the location data, an amount of buffer time to prescribe between the second time and the meeting start time.

15. The system of claim 14, wherein the amount of buffer time is determined based at least in part on a projected commute to a physical location associated with the meeting invitation.

16. The system of claim 10, wherein the computer-readable instructions further cause the at least one processor to:
determine an amount of buffer time based on the meeting start time; and
determine the second time based on the amount of buffer time.

17. A system comprising:
means for determining alarm settings that define a first time for causing an alarm signal to be generated by a client device that is associated with a user account;
means for receiving a meeting invitation that is addressed to the user account;
means for determining that the meeting invitation satisfies alarm update criteria associated with the user account based at least in part on a meeting start time, that is defined in the meeting invitation, being prior to a predefined time-range that is associated with the user account; and
means for updating the alarm settings to define a second time for causing the alarm signal to be generated by the client device responsive to the meeting invitation satisfying the alarm update criteria.

18. The system of claim 17, further comprising:
means for receiving user input that defines the alarm update criteria in association with the user account, the user input defining at least one of: specific user accounts, specific geolocations, specific time zones, or specific date ranges.

19. The system of claim 17, wherein determining that the meeting invitation satisfies the alarm update criteria includes:
identifying a sending account associated with the meeting invitation; and
determining that alarm update permissions, that are defined in association with the user account, permit the updating of the alarm settings in response to the meeting invitation being received from the sending account.

20. The system of claim 17, further comprising means for determining an amount of buffer time based on at least one of the meeting start time indicated within the meeting invitation or location data included within the meeting invitation.
